(19) United States
(12) Patent Application Publication
(10) Pub. No.: US 2009/0103913 A1
(43) Pub. Date: Apr. 23, 2009

(54) MULTIFUNCTIONAL SUPPORTING FRAME FOR A WEB CAMERA

(76) Inventor: Chih-Ming Huang, Taipei Hsien (TW)

Correspondence Address: Chih-Ming Huang, 235 Chung - Ho, Box 8-24, Taipei, 235, TW

(21) Appl. No.: 11/874,934

(22) Filed: Oct. 19, 2007

(51) Int. Cl. G03B 17/00

(52) U.S. Cl. 396/428

(57) ABSTRACT

A multifunctional supporting frame for a web camera, comprises a movable supporting clamping seat having a hollow rectangular receiving chamber; the rectangular receiving chamber being formed by an upper L shape sheet, a middle U shape sheet, and a lower enclosed rectangular sheet; one lateral side of the L shape sheet being extended with a sheet plate; at least one guide post being extended from one surface of the sheet plate; the guide posts being combined with springs so as to be formed as a telescopic structure which is adjustable to have a desire width for clamping an object; and a bendable shaft seat formed by an upper U shape plate and a lower U shape plate which are pivotally engaged. A lens set is installed above the movable supporting clamping seat by using a lens set pin seat.

### FIELD OF THE INVENTION

The present invention relates to webcams (web camera), and particularly to a multifunctional supporting frame for a web camera, wherein a movable supporting clamping seat and a bendable shaft seat are combined. The lens set is installed upon the movable supporting clamping seat. The whole structure is flexible so that it can be fitted to a location to for retaining the web camera. The orientation and height of the lens set are adjustable according to the present invention.

### BACKGROUND OF THE INVENTION

Webcams (web cameras) are widely used with computers, such as notebook computers or table top computers for capturing images which can be further transferred to a farther location for viewing so as to expand the use of the computers, such kinds of devices are for example, I-pod, Bluetooth, Blackberry, etc. Generally the webcam is clamped to a screen of a computer or is located to a place near the screen of the computer. However, in the prior art, the webcam's structure is not suitable to locate the webcam to a desire place, a desire orientation and a desire elevation. However, this induces inconvenience to the users.

Moreover, the assembly seat of the webcam is designed for a desired kind of webcam, but it is not suitable for different kinds of webcams. Thus, there is an eager demand for a novel design which can improve the defects in the prior art.

### SUMMARY OF THE INVENTION

Accordingly, the primary object of the present invention is to provide a multifunctional supporting frame for a web camera, wherein a movable supporting clamping seat and a bendable shaft seat are combined. The lens set is installed upon the movable supporting clamping seat. The whole structure is flexible so that it can be fitted to a location to for retaining the web camera. The orientation and height of the lens set are adjustable according to the present invention.

To achieve above objects, the present invention provides a multifunctional supporting frame for a web camera, wherein a movable supporting clamping seat and a bendable shaft seat are combined. The lens set is installed upon the movable supporting clamping seat. The whole structure is flexible so as to fit the location to be placed the multifunctional supporting frame for a web camera. The lens set is adjustable about the orientation and height.

A multifunctional supporting frame for a web camera comprises a movable supporting clamping seat having a hollow rectangular receiving chamber; the rectangular receiving chamber being formed by an upper L shape sheet, a middle U shape sheet, and a lower enclosed rectangular sheet; one lateral side of the L shape sheet having at least one via holes and being extended with a sheet plate; at least one guide post being extended from one surface of the sheet plate; the guide posts being combined with springs so as to be formed as a telescopic structure which is adjustable to have a desire width for clamping an object; and a bendable shaft seat formed by an upper U shape plate and a lower U shape plate; the upper U shape plate having an upper connecting shaft and the lower U shape plate having a lower connecting shaft; the upper connecting shaft being pivotally engaged to the lower connecting shaft so as to combine the upper U shape plate to the lower U shape plate to form as an H shape structure, the upper connecting shaft being pivotally rotated to the lower connecting shaft; the upper connecting shaft being assembled to the rectangular receiving chamber by using screw units so that the two legs of the upper connecting shaft being assembled to two lateral sides of the rectangular receiving chamber. By the present invention, the lens set C can be placed in different positions, different orientations, and elevations.

The various objects and advantages of the present invention will be more readily understood from the following detailed description when read in conjunction with the appended drawing.

### BRIEF DESCRIPTION OF THE DRAWINGS

FIG. 1 is an exploded schematic view showing the components of the present invention.

FIG. 2 is a schematic perspective view of the present invention.

FIG. 3 shows that the present invention is used to be assembled to a notebook computer.

FIG. 4 shows another application of the present invention.

FIG. 5 shows a further application of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

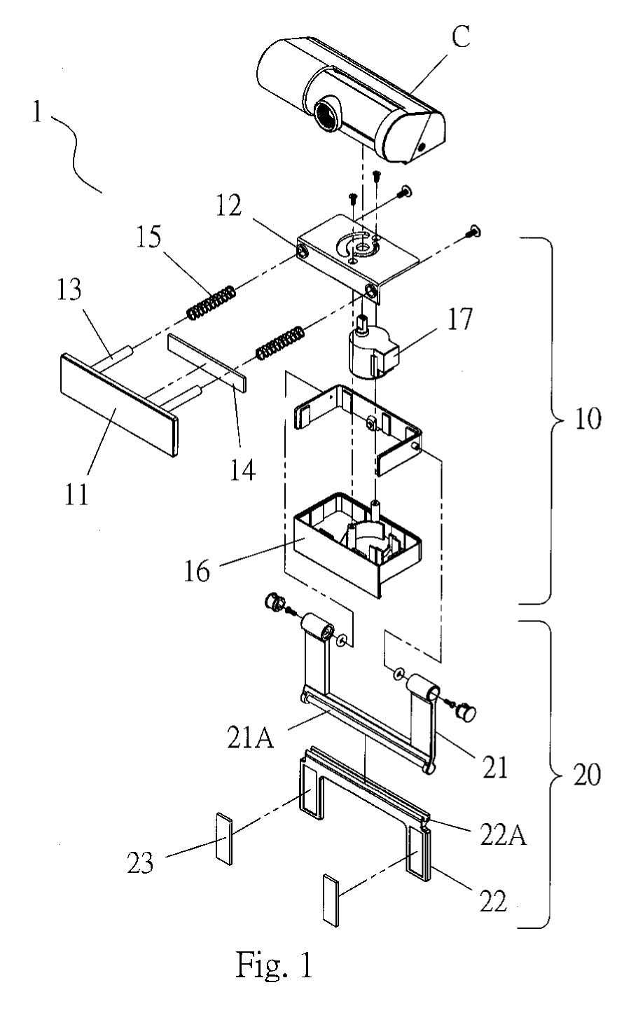

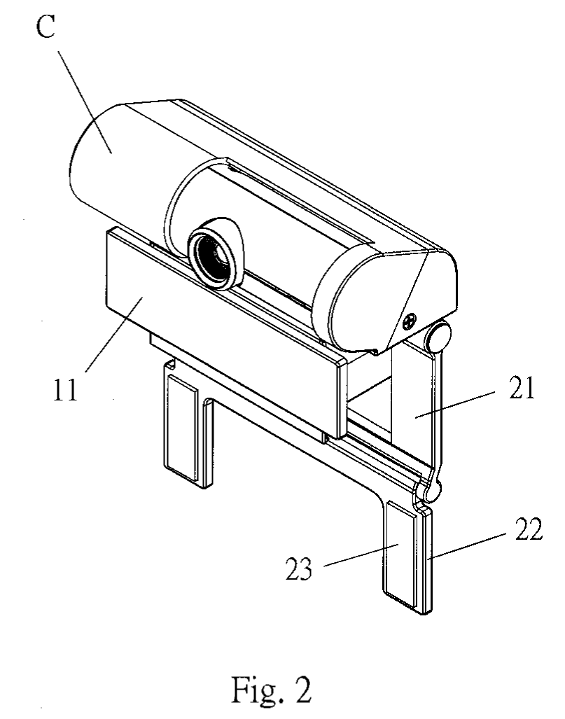

Referring to FIGS. 1 and 2, a multifunctional web camera supporting frame according to the present invention is illustrated for clamping or suspending a web camera to a table. The elements of the present invention will be described herein.

A movable supporting clamping seat 10 has a hollow rectangular receiving chamber. The rectangular receiving chamber is formed by an upper L shape sheet, a middle U shape sheet, and a lower enclosed rectangular sheet 16 (referring to FIG. 1). One lateral side of the L shape sheet has via holes 12 and is extended with a sheet plate 11. At least one guide post 13 is extended from one surface of the sheet plate 11. In this embodiment, two guide posts 13 are illustrated as an example. A stop sheet 14 is at an end surface of the guide post 13. The guide posts 13 are combined with springs 15 so as to be formed as a telescopic structure which is adjustable to have a desire width for clamping an object.

A lens set pin seat 17 is received in the rectangular receiving chamber. A pin in an upper side of the lens set pin seat 17 is protruded out from an upper surface of the L shape sheet for receiving a lens set C. The lens set pin seat 17 has a motor (not shown), such as a step motor, for driving the lens set C to move toward different directions by a control structure with a software.

A bendable shaft seat 20 is formed by an upper U shape plate 21 and a lower U shape plate 22. The upper U shape plate 21 has an upper connecting shaft 21A and the lower U shape plate 22 has a lower connecting shaft 22A. The upper connecting shaft 21A is pivotally engaged to the lower connecting shaft 22A so as to combine the upper U shape plate 21 and the lower U shape plate 22 to form as an H structure. The upper connecting shaft 21A is pivotally rotated to the lower connecting shaft 22A. Furthermore in the present invention, a front side of each leg of the lower connecting shaft is attached with a buffer pad 23.

Referring to FIG. 2, the upper connecting shaft 21A is assembled to the rectangular receiving chamber by using screw units so that the two legs of the upper connecting shaft 21A are assembled to two lateral sides of the rectangular receiving chamber.

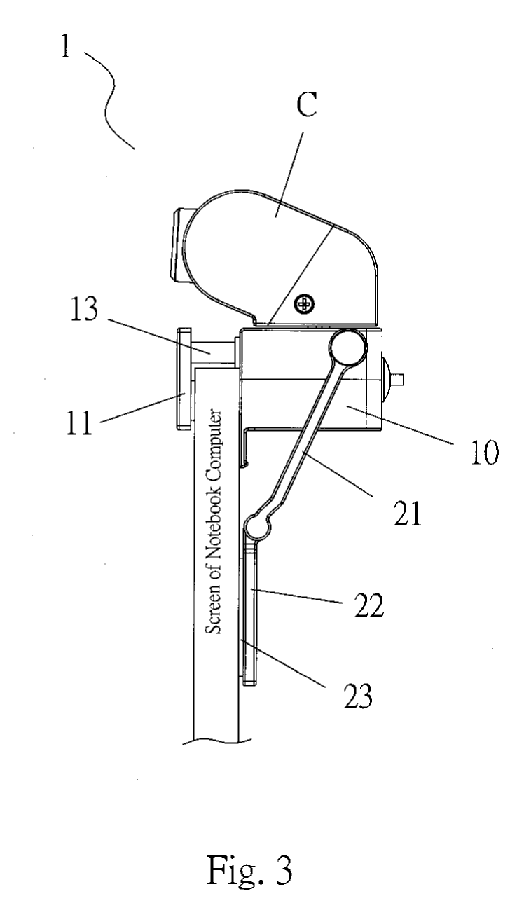

Referring to FIG. 3, the application of the present invention is illustrated. It is illustrated that the structure of the present invention is assembled to a notebook computer. The upper connecting shaft 21A is bent with respect to the lower connecting shaft 22A to cause the lower connecting shaft 22A and rectangular receiving chamber are adhered to a surface of the notebook computer. A distance from the sheet plate 11 to the rectangular receiving chamber is suitable for the sheet plate 11; and the rectangular receiving chamber can clamp a screen the notebook computer so that the camera is located at an upper side of the screen for capturing images.

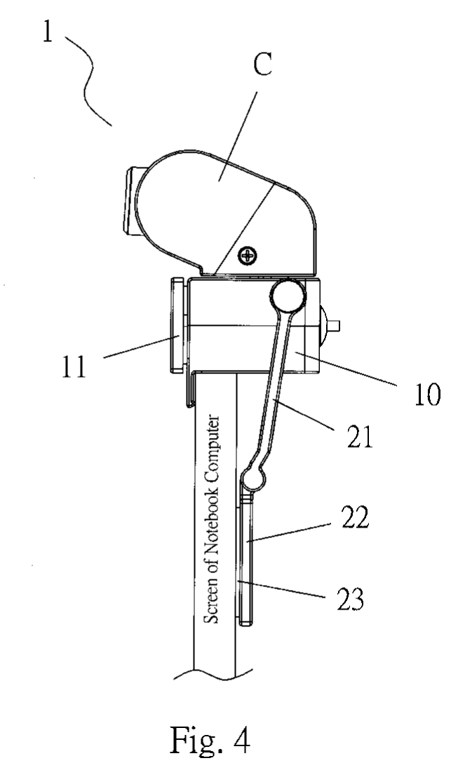

Referring to FIG. 4, it is illustrated that the bendable shaft seat 20 can be lifted up to cause that the rectangular receiving chamber is at an end surface of the notebook of the present invention.

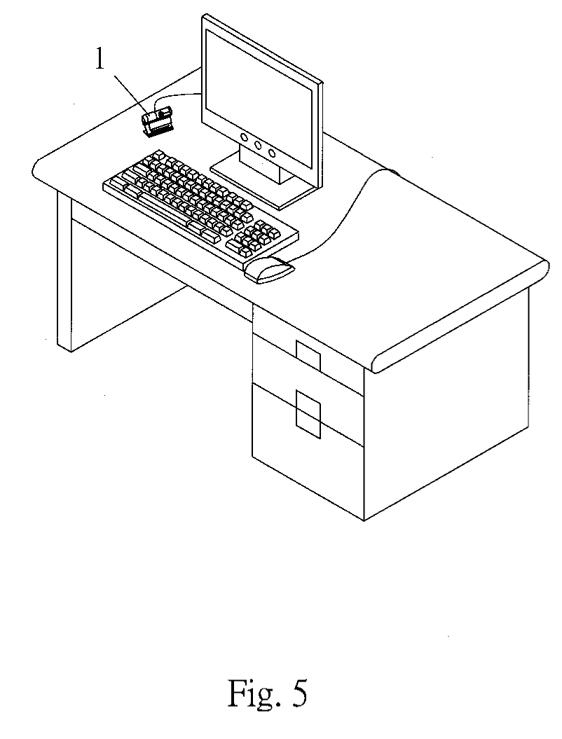

With reference to FIG. 5, moreover, the present invention can be placed on a table aside the screen of a computer device. All these are applications of the present invention.

Furthermore the lens set C can be placed in different positions, different orientations, and elevations.

Advantages of the present invention will be described herein.

The present invention provides multifunctions so that the web camera can be located to a desire location or orientations. Furthermore various kinds of the lens set can be assembled to the present invention at different locations so that the present invention is economic. Furthermore the present invention is novel and inventive.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A multifunctional supporting frame for a web camera, comprising:
a movable supporting clamping seat having a hollow rectangular receiving chamber; the rectangular receiving chamber being formed by an upper L shape sheet, a middle U shape sheet, and a lower enclosed rectangular sheet; one lateral side of the L shape sheet having at least one via holes and being extended with a sheet plate; at least one guide post being extended from one surface of the sheet plate; the guide posts being combined with springs so as to be formed as a telescopic structure which is adjustable to have a predetermined width for clamping an object; and
a bendable shaft seat formed by an upper U shape plate and a lower U shape plate; the upper U shape plate having an upper connecting shaft and the lower U shape plate having a lower connecting shaft; the upper connecting shaft being pivotally engaged to the lower connecting shaft so as to combine the upper U shape plate to the lower U shape plate to form as an H shape structure; the upper connecting shaft being pivotally rotated to the lower connecting shaft; the upper connecting shaft being assembled to the rectangular receiving chamber by using screw units so that the two legs of the upper connecting shaft being assembled to two lateral sides of the rectangular receiving chamber.

2. The multifunctional supporting frame for a web camera as claimed in claim 1, wherein there are two guide posts being extended from the sheet plate.

3. The multifunctional supporting frame for a web camera as claimed in claim 1, wherein a lateral surface of the sheet plate is used as a mark surface or an advertisement surface.

4. The multifunctional supporting frame for a web camera as claimed in claim 1, wherein a lens set pin seat is received in the rectangular receiving chamber; a pin extends from an upper side of the lens set pin seat and is protruded out from an upper surface of the L shape sheet for receiving a lens set; the lens set is with a motor for driving the lens set to move toward different directions by a control structure with a software.

5. The multifunctional supporting frame for a web camera as claimed in claim 1, wherein a front side of each leg of the lower connecting shaft is attached with a buffer pad.

6. The multifunctional supporting frame for a web camera as claimed in claim 1, wherein a stop sheet is installed at an end surface of the guide post.
